(19) United States
(12) Patent Application Publication
(10) Pub. No.: US 2005/0004869 A1
(43) Pub. Date: Jan. 6, 2005

(54) System and method for managing virtual inventory of payment instruments

(76) Inventor: Richard Kane Leurig, Brentwood, TN (US)

Correspondence Address: Stuart R. Hemphill;DORSEY & WHITNEY LLP, Intellectual Property Department, 50 South Sixth Street, Suite 1500, Minneapolis, MN, 55402-1498, US

(21) Appl. No.: 10/611,081

(22) Filed: Jul. 1, 2003

(51) Int. Cl. G06F 17/60

(52) U.S. Cl. 705/40

(57) ABSTRACT

A method and system for managing virtual inventory of payment instruments includes providing a plurality of blank checks without pre-printed serial numbers; assigning a batch of virtual serial numbers by an issuer to a trustee; creating a serial number by the trustee at each transaction; printing the created serial number on a blank check; and transmitting the created serial number and one of the assigned serial numbers to the issuer.

### FIELD OF THE INVENTION

The present invention generally relates to payment instrument printing and processing methods and systems. More particularly, the present invention generally relates to methods for managing an inventory of, and printing an dispensing different types of, magnetic ink character recognition (“MICR”) encoded payment instruments processable through the banking system, such as money transfer payment instruments for money transfers, money orders, gift certificates, payroll or other checks and the like, on secure printers operated by trustees.

### BACKGROUND OF THE INVENTION

Retail chains and individual stores wish to increase customer services at their many locations by offering convenient financial services, such as money order purchases, gift certificates and money transfers. Many retail establishments, such as grocery stores, convenience stores and financial centers, find that they can increase customer flow by offering for sale and dispensing a variety of payment instruments. These services, however, require the involvement of a well-known and financially secure entity to insure that the resulting instruments are universally accepted, to provide the blank form instruments to a large number of outlets from which they can be issued, and to provide the financial accounting systems for tracking the issued instruments.

For example, conventional money order transactions involve a customer, a trustee, and an issuer. In a typical transaction, the customer is an individual seeking to purchase a money order. The trustee is the operator of a retail establishment from which the customer physically receives the money order. The issuer is the large, well-known company that is financially responsible for the bank account from which the money orders are paid.

To project its money order services to a larger number of trustee locations, not under its control and not always having their own reliable financial controls or the resources for major financial responsibility, the issuer needs to establish security systems. Because the money orders are, in effect, blank checks drawable on its account, the issuer needs to establish accountability for each such document. This is typically done by supplying a trustee with a limited stock of preprinted, serial-numbered forms, i.e., blank stock ready for completion as “live” payment instruments. These are printed on the customary special security paper as used for checks and money orders, bear the appropriate MICR-encoded routing and transit information and have blanks for insertion of specific transaction information. By contract with the issuer, the trustee becomes chargeable for the money orders printed on this stock.

To enable typical money order transactions, the issuer would first print a defined sequence of serial-numbered, blank money order forms and then physically deliver blank stock containing the defined sequence of blank money order forms to the trustee or its administrative parent. The issuer would then give the trustee authority both to print the amount (and other particulars) of each money order using the blank form stock and to issue each money order, thus creating a payment instrument, payable in a specific amount and widely accepted. By this grant of authority, the issuer agrees to honor all such instruments issued by the trustee in accordance with its contract with the issuer. The trustee, in turn, contractually agrees to be charged by the issuer for all of the money orders prepared from the money order serial-numbered, blank stock.

The customer in this typical money order transaction would approach a trustee location and request a money order for a particular amount (“requested amount”). The customer would then give the trustee employee an amount of cash equal to the requested amount plus any agreed service fee. After receiving the cash, the trustee employee would cause the requested amount to be printed on the amount line of a money order form from serial-numbered, blank stock and physically issue the completed, serial-numbered money order to the customer. A record of the issued money order and its serial number is created to send to the issuer. After receiving the money order, the customer would eventually use it to pay a vendor, bank, or the like (“third party”). Through the banking/clearing system, the third party would present the money order to the issuer's bank and the issuer's bank would (via the banking/clearing system) credit the third party with an equivalent amount of funds. The issuer bills the trustee for the amount of the money order as reported by the trustee and reconciles the cleared money order with the issued instrument record created at the time of issue. Absent fraud or other problems, the issuer collects from the trustee money collected from purchasers corresponding to each money order on which the issuer must pay. Both the issuer and the trustee may earn fees paid by the money order purchasers. Problems can, of course, arise if any money order in the sequence of serial-numbered, blank stock becomes disputed as to the amount or the fact of issuance by the trustee, so that reconciliation fails. Careful physical control over the serial-numbered, blank stock, including secure printers for holding the serial-numbered blank stock and means for determining irregularities in printing, are used to deter problems.

This issuer-trustee arrangement is desirable, because it allows even small, relatively unknown trustees to provide their customers with universally accepted negotiable instruments. However, it is important to note that the trustee in the conventional systems is chargeable almost without exception for each of the blank stock money order forms it receives. That is, although the money order issued is drawable upon the issuer's bank account and the issuer will honor the instrument, the trustee remains contractually chargeable for the amount of all the money orders. This arrangement generally comports with the parties' expectations, because the trustee has physical control of the serial-numbered, blank stock of money order forms and operates the secure printer, and because the trustee should always receive the correct amount of cash from the customer. To assist in management and control over the money order transactions occurring at a trustee, the issuer uses remote data collection means to gather stored data records reflecting the trustee/customer money order transactions. For example, U.S. Pat. Nos. 5,647,677 and 5,667,315 show, respectively, arrangements for polling a remote money order dispenser and for coupling a host computer to a money order dispenser at selectable, predetermined times to gather transaction data. The issuer needs to have both reasonable management controls and a high level of trust that its trustees will pay for a serial-numbered, sequence of money order sales that matches the issuer's payouts on that same sequence.

A second payment instrument example arises with money transfer payments. Money transfer transactions are increasingly important and can also involve an issuer-trustee relationship and issuance of serial-numbered payment instruments by trustees. Conventional money transfer transactions involve a send customer (“sender”), a receive customer (“recipient”), a send transaction trustee (“STT”), a receive transaction trustee (“RTT”), and a transaction processing company (“TPC”). In a typical transaction, the sender and the recipient are both individuals. The STT and the RTT are usually both retail businesses, such as a convenience store or grocery store. The TPC is a large, established company that has contractual relationships with a large number of STT's and RTT's with operations in a large number of locations.

The payout of a money transfer transaction is at an RTT and can occur in several ways. The recipient gets one or more drafts with the recipient named as payee, and the drafts(s) cover the entire amount to be paid out. Where cash is to be paid out, one or more drafts are endorsed by the payee and exchanged for cash.

To enable the printed instruments needed for money transfer payouts, the TPC handling money transfer transactions would first print a defined sequence of serial-numbered, payment instrument forms, blank as to payee and amount, and then physically deliver that blank form stock to a trustee that may serve as an RTT. The TPC would then give the trustee authority both to fill in the payment instrument's amount as full or part payment of a money transfer and to issue each payment instrument as a draft payable to the money transfer recipient. By this grant of authority, the TPC agrees to honor such payment instruments physically issued by the trustee.

The sender in a money transfer transaction first approaches an STT location and requests to send a particular amount of cash (“transfer amount”) to the recipient. The sender would then give the STT employee enough information to identify the recipient and pay to the STT an amount of cash equal to the requested amount plus the agreed service fee. After receiving the cash, the STT location would communicate the recipient's identity and the transfer amount to the TPC. Eventually, the sender would contact the recipient to tell him or her of the transfer and perhaps also an RTT location. The TPC would charge the STT for the transfer amount plus the TPC's service fee.

The recipient in this transaction would approach an RTT associated with the TPC and request to receive the transfer amount. Next, the RTT would then contact the TPC, and then request some form of identification. If the TPC approves the payout transaction, the RTT would print an instrument payable to the recipient, allow the recipient to indorse the instrument, and give the recipient an amount of cash, up to the maximum cash payout. The RTT could also use the serial-numbered, blank stock to issue one or more instruments payable to the recipient and drawable upon the TPC's bank account. A record of the issued instrument(s) and its (their) serial number(s) is created to send to the issuer.

Unlike the trustee relationship in conventional money order transactions, however, the TPC remains primarily responsible for the payment instruments prepared from the blank stock in the RTT's possession and used for money transfer payouts. That is, although the RTT physically may give the fully-printed payment instrument to the recipient, absent fraud or some irregularity, the RTT is not liable to the TPC for that instrument in the same manner as for a money order sold to a customer. This arrangement also comports with the parties' expectations, because the RTT does receive any cash from its “customer,” the recipient. It is also important to note that this system requires prompt transaction reporting to the TPC from the STT, so that the transaction amount is quickly available to the recipient, and from the RTT, to prevent the recipient from fraudulently requesting the transfer amount more than once, from different RTT's. The transaction information also permits the issuer to reconcile a cleared payment instrument negotiated by a customer with the record created at the time of issue.

Although the same entities frequently serve as “trustees” for money order sales transactions and as RTT's for money transfer transactions, the differing charging rules and responsibility arrangements for these transaction types has in the past necessitated separate supplies of blank form payment instruments. That is, although the same trustee retail location frequently conducts both money order sales and money transfer payout transactions using payment instruments drawable upon the same issuer, conventional systems require two separate blank form stocks of sequenced, serial-numbered payment instruments. One sequence of payment instruments is used for money order sales transactions, which are chargeable to the trustee. The other sequence is used for money transfer payout transactions and, absent irregularities, is not chargeable to the trustee by the TPC. Thus, two types of preprinted, serial-numbered stock are often used and it is important to both parties to keep all serial numbers in both sets of serial-numbered stock fully accounted for, whether void/not voided and what kind of instrument in what amount is issued.

This dual blank stock problem is magnified because most issuers/TPC's desire the use of secure printers. That is, because these transactions require that the issuer/TPC widely distribute serial-numbered, blank stocks of payment instruments on which the issuer is liable under standard negotiable instruments laws, most issuers/TPC's desire that the trustees keep the serial-numbered, blank stock in a secure place. This need, in turn, can require the use of two secure printers, which leads to additional drawbacks, in space requirements and costs, including printing, warehousing, delivering and retail-level storing of the inventory of the serial-numbered, blank stock. U.S. patent application Ser. No. 10/011,695, filed Dec. 7, 2001, offers a system and method by which the duplication of printers and duplication of serial-numbered instrument stock at a retail site can be avoided; however, it still requires printing, warehousing, delivering and retail-level storing of one inventory of the serial-numbered, blank stock.

While MICR printers capable of the required printing of checks at point of issue are now available, the need for security and accountability as to individual payment instruments has limited their wide use. Accordingly, there is a need for a method and system that can permit retail level use of MICR printers but permits the inventory of instruments so printed to be properly managed. Such a method and system must conform to the parties' traditional expectations regarding charges made to the trustee and other financial responsibility for each instrument and still maintain a high degree of physical security.

### SUMMARY OF THE INVENTION

The present invention provides a method and system for managing an inventory of payment instruments, such as money transfer payment instruments for money transfers, money orders, gift certificates, payroll or other checks and the like, processed through an issuer's banking system, printed and dispensed on a printer by a trustee. One aspect of the present invention is a method of creating and managing a virtual inventory of serial-numbered payment instruments, comprising the steps of providing blank instruments (with the exception that the blank instruments may include standard or customary features), assigning a batch of virtual serial numbers by an issuer to a trustee, printing one of the assigned serial numbers and transactional information on a blank instrument at each transaction, and transmitting the serial number and transactional information associated with the blank instrument to the issuer.

In an alternative embodiment, the present invention is a method of managing an inventory of payment instruments, comprising the steps of providing a plurality of blank instruments without pre-printed serial numbers, assigning a batch of virtual serial numbers by an issuer to a trustee, creating a serial number for each transaction, printing the created serial number and transactional information on a blank instrument, and transmitting the assigned serial number, the created serial number and transactional information of the blank instrument to the issuer.

While multiple embodiments are disclosed, still other embodiments of the subject invention will become apparent to those skilled in the art from the following detailed description. As will be apparent, the invention is capable of modifications in various obvious aspects, all without departing from the spirit and scope of the subject invention. Accordingly, the drawings and detailed description are to be regarded as illustrative in nature and not restrictive.

### BRIEF DESCRIPTION OF THE DRAWINGS

FIG. 1 is a schematic diagram of a prior art preprinted, serial numbered payment instrument printing and inventory system.

FIG. 2 is a schematic diagram of one embodiment of a blank stock-instrument printing and serial number virtual inventory system in accordance with one embodiment.

FIG. 3 shows a blank form payment instrument before a serial number is applied.

FIG. 4 shows a blank form payment instrument after a serial number is assigned and printed with relevant transaction information.

FIG. 5 is a flow chart of one embodiment of a payment instrument printing and processing method seen from the inventory system viewpoint.

FIG. 6 is a flow chart of one embodiment of a payment instrument printing and processing method seen from the trustee terminal viewpoint.

### DETAILED DESCRIPTION

Overview of Prior Art

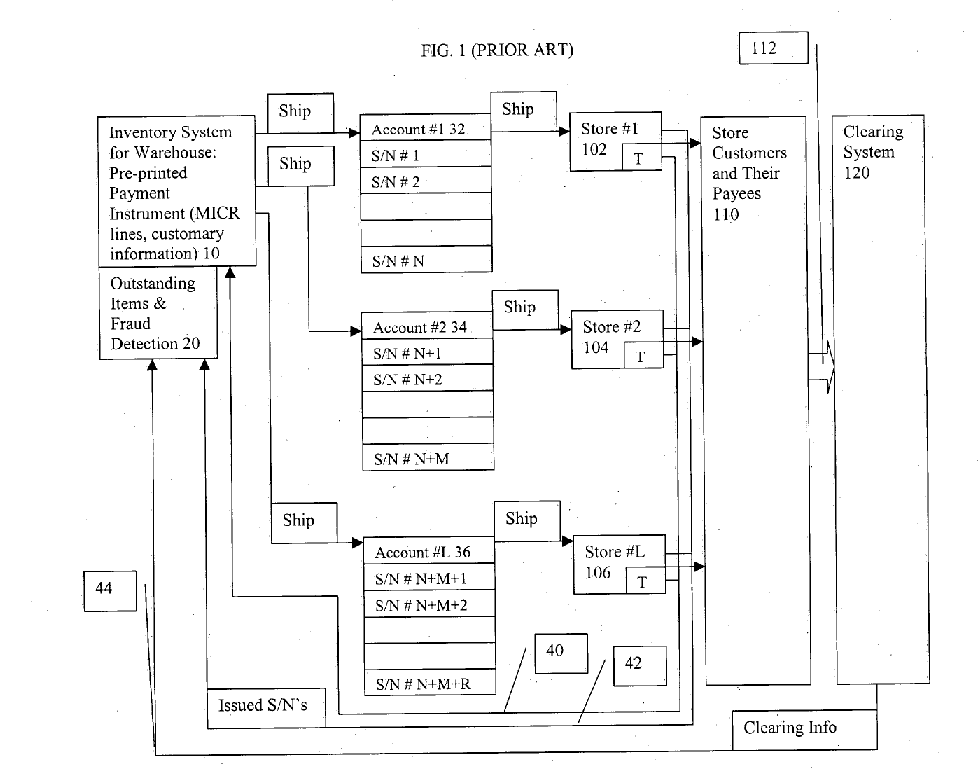

In FIG. 1, is shown a prior art system for providing serial-numbered blank payment instrument forms to a variety of trustee terminals T, The pre-printed, serial-numbered payment instrument blank forms are kept at a warehouse 10. By way of example, the trustee terminals T are located at stores 102, 104, 106, although gas stations, dedicated kiosks, financial institutions and other trustee locations where payment instruments can be issued are also possible. Although for simplicity only one store is shown for each account 32, 34, 36 shown, an account may be a large chain having hundreds or thousands of stores. Also for simplicity, we assume each store has only one terminal T for printing payment instruments, although a store could have more than one trustee terminal T participating in this system. In one embodiment, each trustee terminal T has an associated secure printer, meaning that access to its interior and the forms loaded or stored within it is restricted, for example, by key access, a software lock controlled by a password or biometric authentication sensor or other security device. In the following, communication to the trustee or trustee terminal may be understood as communication to the secure printer and/or its control system.

As used herein, “payment instrument” refers to a document that can be issued as a money order sold to a customer, a gift certificate, a payroll or other check, a money order for a trustee payment to a vendor, a money order for trustee reimbursement, or for other similar uses, where the amount of the instrument is paid by the drawer of the instrument, who is also the issuer. The payment instrument is collectible and paid through banking channels much like a check, e.g., a personal check handled by clearing procedures for checks and similar instruments involving the Federal Reserve System and participating banks.

Further referring to FIG. 1, the serial-numbered, blank payment instrument forms are shipped to the trustee terminals either by shipping them directly to stores 102, 104, 106 or to a central administrative site for the store group account 32, 34, 36. The central administrative site then distributes the forms to individual trustee terminals associated with the account. In either case, continuing shipments to many locations are involved, with risks of loss and delay. When a store receives a supply of serial-numbered, blank forms and these are loaded in the trustee terminal T, the serial numbers are also loaded into the control system for the secure printer so that it can check and report instrument by instrument usage.

A store can place an order for replenishment of its supply of serial-numbered instrument forms by contact with the warehouse 10, via communication link 40. When a store has issued an instrument by printing the required transaction-specific information on a serial-numbered blank payment instrument form and providing it to a customer, the transaction information (including issued instrument serial numbers, amounts, instrument type, etc.) is accumulated in a record to be sent to an Outstanding Items and Fraud Detection System 20, which is associated with the issuer and the warehouse 10. Preferably this is carried out on communication link 42. To save on communication costs, such transaction information is accumulated into batch reports that are sent to Outstanding Items and Fraud Detection system 20 on a scheduled, periodic basis, such a daily or every other day.

The instruments issued by the trustee terminal of a store 102, 104, 106 are passed on by store customers to various payee parties, as indicated at 110. Eventually, these are taken to a bank or similar financial institution for crediting to a payee account or for cashing, as indicated at 112. They then enter the clearing system 120. Eventually, these items appear as debits against an issuer account (not shown). To help track what payments have been made and what instruments are still outstanding, information from the clearing system, including instrument serial numbers and amounts, is communicated to the Outstanding Items and Fraud Detection system 20 on communication link 44. This permits the issuer to track and reconcile instruments that have been both issued and properly presented and to track instruments that have been issued and not yet properly presented. It also may permit the identification of instruments that are presented in duplicate (improperly) or that have some other irregularity in presentment.

As part of the warehouse 10, there is a physical inventory system that processes and issues orders for replenishing the supply of serial-numbered, blank payment instrument forms. This system handles both incoming trustee terminal form orders and also tracks the warehouse's need to place a new, outgoing printing order, when the inventory of serial-numbered, blank payment instrument forms in the warehouse gets too low. When a predetermined warehouse threshold is reached, then a new print order will have to be issued, typically for thousands or hundreds of thousands or more serial-numbered, blank payment instrument forms. Each form must bear a specified serial number from the appropriate range of serial numbers selected by the issuer and routing and transit (R&T) information, with the required MICR information conforming to the format used in automated clearing. This new inventory must then be received, logged into the physical inventory system by serial number, warehoused and logged out by serial number and shipped to individual trustee terminals T as needed.

As the number of instruments issued has increased, the existing systems face the problem of serial number exhaustion, caused by field size limitations in systems and/or on documents. It is undesirable to repeat serial numbers, from an accounting viewpoint. Use of preprinted stock causes the entire range of serial numbers shipped to be consumed, even if one or more of the blank forms are voided due to a defect or error in issuing, resulting in no valid instrument being issued for certain serial numbers. Use of preprinted forms for training also consumes serial numbers with no valid instrument being issued. While larger serial numbers may be accommodated by system modifications, these eventually present challenges to the processing systems,

### OVERVIEW OF ONE EMBODIMENT

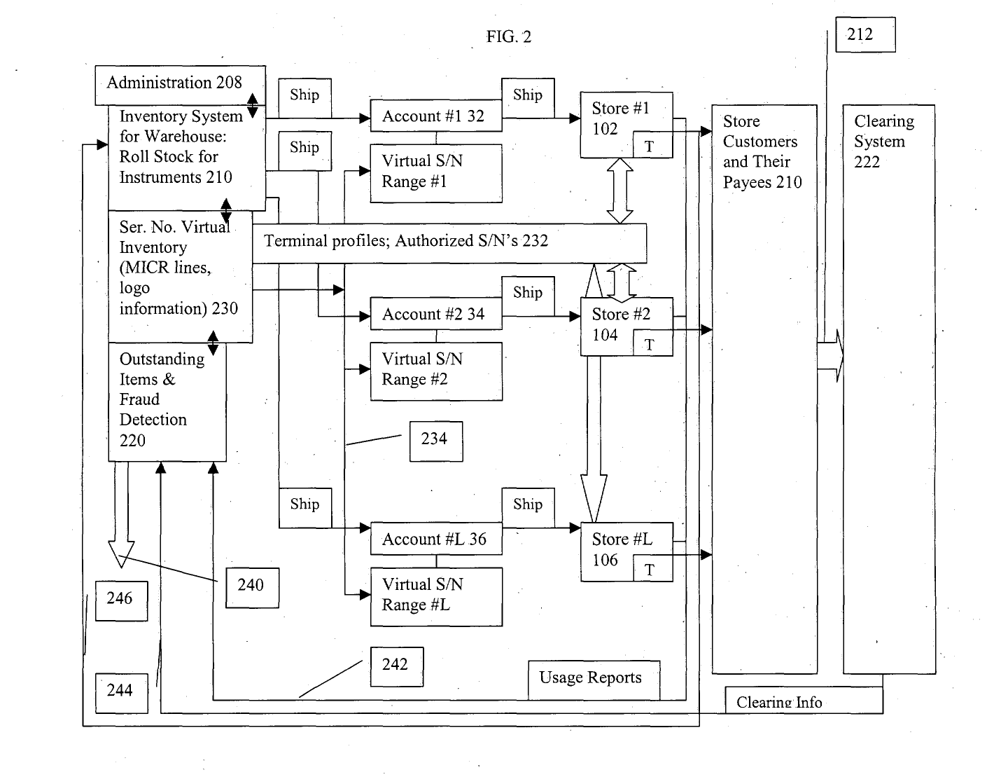

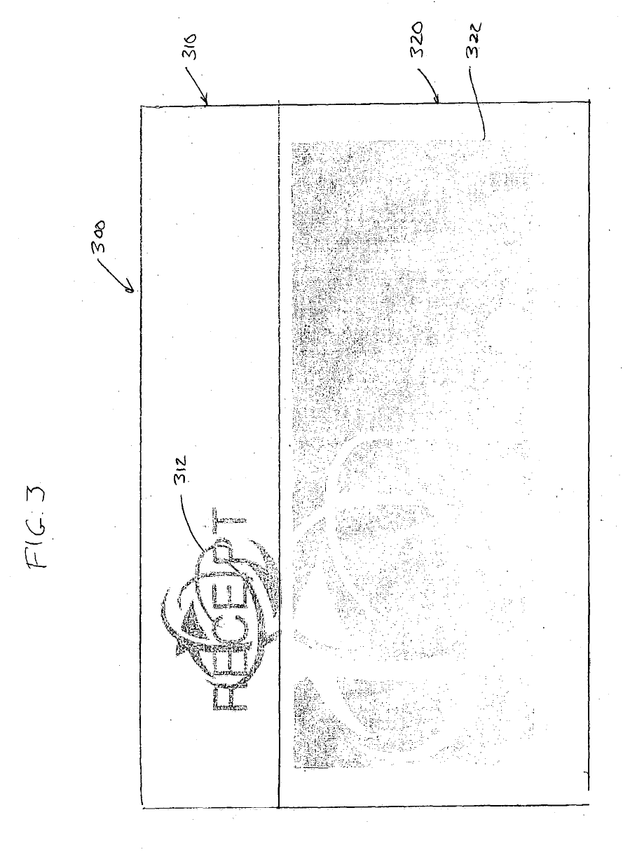

FIG. 2 shows in overview one embodiment of an improved system. To avoid the production, storage, physical tracking and shipping of an actual inventory of serial-numbered, blank payment instrument forms, the present system defines and manages a “virtual inventory”. It is then possible to inventory blank stock of forms that use security paper and may have other generic financial instrument attributes, such as background art, but that have no serial numbers for individual instruments and no MICR line with R&T information or other MICR elements. This blank stock may also omit names and logos that are specific to specific accounts; alternatively, blank stock may be generated that is specific to an account but has no serial numbers for individual instruments or MICR line with R&T information or other MICR elements. (FIG. 3 shows an example of a blank form from this blank stock, generic for any account, and will be explained further below). The generic blank stock may be used for any account or store that has a MICR capable secure printer associated with its trustee terminal T and participates in the virtual inventory. The terminal and secure printer include a computer control system for its security features, as well as the various interactions and operations involved in issuing instruments as described below. Hardware may be a conventional computer or processor; software embodies the functions described below and in the related drawings. Because the existing system for pre-printed, serial-numbered blank forms may continue as to some accounts or stores, the present system is designed to be compatible with the existing physical inventory systems (i.e., with preprinted, serial-numbered, blank payment instrument forms), as will be described later below.

As shown in FIG. 2, the generic, blank instrument stock is stored in warehouse 210, with an associated Serial Number Virtual Inventory System 230 and an Outstanding Items and Fraud Detection System 220. All layers 210, 220 and 230 are linked to each other an to as Administration layer 208 for internal communication. The Serial Number Virtual Inventory System 230 has a communication link 234 to the accounts 32, 34, 36 and a communication link 232 to individual stores 102, 104, 106. While a physical inventory of the amount of blank stock on hand needs to be kept, there is no need to keep a physical inventory by serial number of each instrument and less need for security. From the warehouse 210, blank stock is shipped to trustee terminals T when needed, either by shipping the blank stock directly to stores 102, 104, 106 or to a central administrative site for the store group account 32, 34, 36. The account's central administrative site then distributes the blank stock to individual stores and trustee terminals associated with the account. In either case, a smaller number of shipments are involved, with less concern about security than with preprinted serial-numbered blank payment instrument forms, because the blank stock is less susceptible of abuse and need not have each individual form accounted for by serial number. Because larger numbers of blank instruments can be shipped at one time and stored at the stores 102, 104, 106 or at a central administrative site for the store group account 32, 34, 36 with, less concern about loss or abuse, shipping can occur well ahead of a projected date of depletion, which reduces risks of delay. A trustee terminal T can place an order for replenishment of its supply of such forms by contact with the blank stock warehouse 210, via communication link 246, independent of its need for serial numbers, or indirectly order over link 234 with forwarding by the Serial Number Virtual Inventory System 230.

Creating Virtual Inventory

Conventional orders for pre-printed, serial-numbered blank payment instrument forms are replaced in the embodiment of FIG. 2 by a virtual inventory defined by serial numbers the issuer selects to be used and by requests for serial numbers from that inventory. This proceeds in Serial Number Virtual Inventory System 230 as follows. First, a “mega-batch” of virtual serial numbers may be defined, containing typically hundreds of thousands or one or several million instrument numbers. These numbers will have associated R&T information, because it will be assumed that all instruments actually printed using this virtual inventory of serial numbers will be cleared to the same bank (and account, if specified) of the issuer. (However, if required, different parts of the mega-batch serial number inventory could be assigned different R&T information. The assignments could be made in the mega-batch definition, the macro-batch definition or any time before printing an instrument using the serial number.) Once defined, these serial numbers are held in the virtual inventory, available for allocation to any account 32, 34, 36, for example to one or more retail chains that have a number of stores. They may also be held for allocation to particular stores. In either case, this level of allocation is not a specific authorization to print any instrument bearing the allocated serial numbers, which remain virtual serial numbers until they are printed.

Second, the next level of allocation of defined serial numbers to accounts or particular stores is done by designation of portions or defined ranges of the mega-batch as macro-batches associated with accounts or particular trustee terminals. A characteristic of this level is that like the mega-batch, there is still no specific authorization to a trustee terminal to print any instrument bearing the allocated serial numbers. This allocation is a matter of planning and advance accounting. The Serial Number Virtual Inventory System 230 allocates the numbers to accounts or particular stores (and may notify them) but will not yet notify any trustee terminal of its allocated and authorized range. Allocation of macro-batches will be done based on expected usage rates, although it cannot be predicted that all accounts or stores will exhaust their allocated ranges of a mega-batch at the same time. A typical macro-batch might be 500 serial numbers but could be any level suitable, based on expected need. A macro-batch allocation may be communicated on communication link 234 in the form of a unique virtual serial number range.

Third, each trustee terminal T in the stores 102, 104, 106 gets an initial micro-batch allocation. This allocation is communicated to the trustee terminal in stores 102, 104, 106 and is tracked in the Serial Number Virtual Inventory System 230 over communications link 232. The allocation of a micro-batch is an authorization to the particular trustee terminal T located at a store (as noted above, for simplicity, we have assumed that each store has only one terminal) to actually print and issue instruments using each serial number in the allocated micro-batch. Thus, this allocation of serial numbers corresponds to the prior shipping of pre-printed, serial-numbered blank payment instrument forms. A benefit is that the “shipment” here occurs electronically from the virtual inventory. Each micro-batch inventory of numbers must be managed with care similar to that for a physical inventory of serial-numbered forms, but no physical shipping costs are incurred and risks of delivery delay are limited (at least where reliable electronic communications are available). To facilitate careful management of each micro-batch, a micro-batch is a relatively small number, such as 50 or 100 serial numbers. While consecutive numbers would not be required, for human review of records of issued instruments and to facilitate identification of any reconciliation or other exceptions within batches, ranges of consecutive numbers are desired. Also, while micro-batch serial number ranges of 50 or 100 are practical for human “chunking”, any batch size range that is sufficient to last for at least a few days is acceptable.

The inventory of micro-batch serial numbers is used in the secure printer of the assigned terminal to create from the blank form stock a sequence of issued payment instruments printed with the serial numbers, all MICR R&T information and all other information for an instrument that can be negotiated and cleared. Each document so printed is issued to a customer or other user and from the point of issue handled essentially as if it had been part of a preprinted, serial-numbered blank form. Wastage of virtual serial numbers will be rare or non-existent, because instruments will only be printed at the end of a completed money order or similar instrument issue transaction, when the transaction has been finalized.

To be eligible for use of a micro-batch, a trustee terminal should have in place a terminal profile that specifies significant parameters of its operating relationship with the issuer systems. This profile includes, for example, the business rules for the specified transactions and resulting issued instruments that may be printed using the blank stock and the micro-batch numbers.

Replenishing and Tracking Inventory

The allocation of serial numbers to a trustee terminal in a particular store 102, 104, 106 as shown in FIG. 2 proceeds dynamically, starting with the initial inventory micro-batch assigned. However, as noted, for accounting control each micro-batch is relatively small, consisting of about 50 or 100 numbers. Thus, the numbers allocated and authorized for use in a micro-batch may be used up after several days, and a trustee terminal's authorized serial number inventory may need to be replenished. Replenishment before exhaustion is important to avoid loss of business. Tracking serial number usage is essential to security to reduce fraud. To facilitate replenishment and tracking, each terminal T at each store 102, 104, 106 has as part of its assigned terminal profile, at least one replenishment threshold (e.g., 20 or 25 authorized serial numbers remaining unissued) and a reporting profile. Once a store is printing instruments using numbers in a micro-batch, those numbers will be recorded in the issued instrument reporting file. The reporting profile will determine, based on a predetermined schedule, how often the data in the issued instrument reporting file will be sent as a usage report to the Serial Number Virtual Inventory System 230. For example, a usage report might be communicated once a day, at the end of each day. Reporting may alternatively be scheduled to occur with each instrument issued or each transaction (or every 2^{nd}, 5^{th} or n^{th}, etc. transaction), although this would require more communications overhead. The terminal profile may also specify logos, formats for various kinds of instrument permitted from the terminal and other business rules that govern use of each trustee terminal. These profile elements are stored and updated at an administrative level of the Serial Number Virtual Inventory System 230 and may accommodate variations between and among accounts 32, 34, 36 and terminals within an account.

A replenishment threshold is a number used to compare to the trustee terminal's counter of how many serial numbers are currently available in its assigned micro-batch(es). As part of an issued instrument report, the terminal can report up to Serial Number Virtual Inventory System 230 both its current available serial number count and its replenishment threshold number or just the result of comparing the two. If the threshold for replenishment is met, then a new micro-batch order can be formulated at the terminal or at the Serial Number Virtual Inventory System 230, after receipt of the terminal's report. This will result in allocation and authorization to the trustee terminal of a replenishment micro-batch that includes the next sequence of authorized serial numbers, which will be used when the currently available micro-batch serial numbers are exhausted.

In one embodiment, it is desirable to have controls on the number of micro-batches that are at any one time authorized for an trustee terminal and for which the Serial Number Virtual Inventory System 230 has not yet received all issued instrument records. As explained further below, this is done by maintaining a pending micro-batch count for each trustee terminal. This count encompasses each micro-batch authorized to the trustee terminal that has any serial numbers not yet accounted for to Serial Number Virtual Inventory System 230 as issued instruments. Thus, the count is incremented when a new micro-batch is authorized to a trustee terminal and decremented when all the serial numbers in an authorized micro-batch have been used in issued instruments. A terminal is eligible for a replenishment micro-batch only if the pending batch count satisfies the limit parameter.

As a fail safe, each trustee terminal can also have a second replenishment threshold, a special order initiation threshold. This a number less than the first replenishment threshold (e.g., 15 or 20 authorized serial numbers remaining unissued) and represents a level that, instead of being used with a normal periodic usage report, will lead to the initiation of a special communication, with a usage report and special micro-batch serial number order. This helps ensure that a timely order is placed if high usage causes the serial numbers in the currently used micro-batch to be depleted faster than expected, such that waiting for the next scheduled usage report from the terminal may result in exhaustion of the serial numbers in the currently available micro-batch before this reporting occurs. When this special communication is issued, not only is the special order placed, but the usage report updates the status regarding issued instruments. In one embodiment, both the special order initiation threshold and the replenishment threshold are configurable numbers that are part of the terminal profile. Thus, they may be adjusted from time to time responsive to the needs of a particular trustee terminal as these are recognized or evolve. In one embodiment, a request for a micro-batch included with a special communication is subject to the same eligibility requirement based on batch count limit as an order resulting from a scheduled periodic report.

When a terminal places or causes a replenishment order based on a normal periodic usage report or a special micro-batch replenishment order, then (subject to eligibility) another micro-batch is allocated and authorized for the terminal. That is, inventory is “built” by providing to a terminal a next sequence of authorized serial numbers and any other information needed to print the serial numbered instruments. Typically, the R&T information, logos, instrument user instructions, etc., will already be available to the terminal, provided as part of a terminal profile or as part of an update to the terminal profile, but it may be communicated with any micro-batch.

Clearing and Reconciliation

The usage reports communicated on link 242 and the clearing information communicated on link 244 are received at the Outstanding Items and Fraud Detection System 220. As needed, this information is shared with the Serial Number Virtual Inventory System 230. These systems analyze the incoming data for accounting and reconciliation purposes. In particular, the reconciliation may detect discrepancies between details of issued instruments reported from the trustee terminals and the details for the same serial number as reported with clearing information,

Blank Stock and Instrument Formats

FIG. 3 shows a blank form for an instrument 300 as it appears in the blank stock sent to a terminal. As can be seen, the instrument 300 comprises a main portion 320 and a receipt stub 310. The blank stock instrument includes no serial number, no MICR line at all, in fact no printing except the security and cosmetic attributes included in a logo design 312 for the receipt stub and a background design 322 for the main portion 320. The back side (not shown) may include preprinted lined fields and instructions to facilitate endorsement and/or state terms of instrument usage.

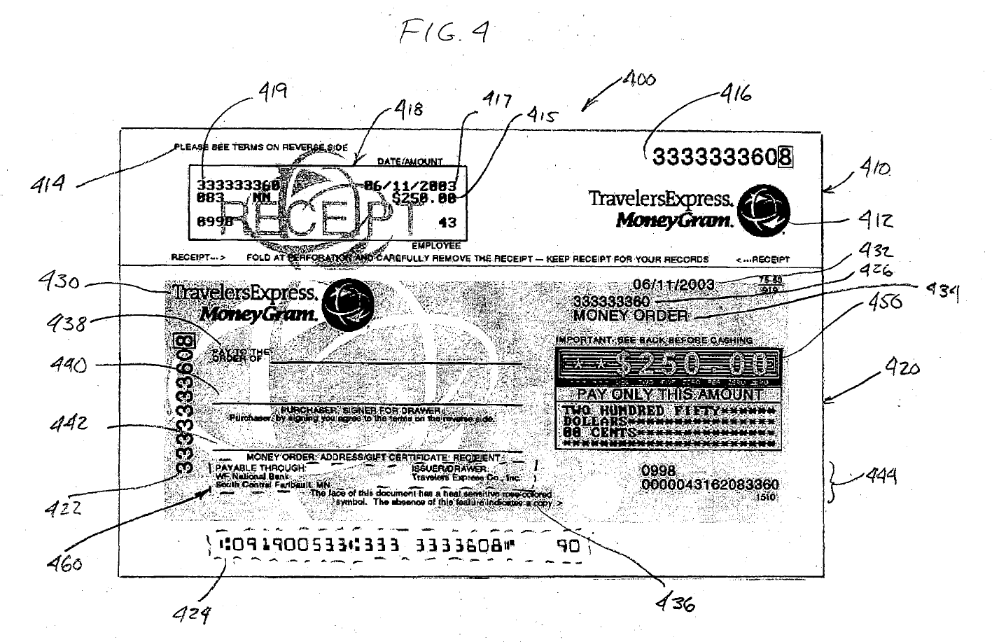

FIG. 4 shows an issued money order instrument 400 after printing with a serial number and other information included in an issued instrument. As depicted in FIG. 4, the instrument 400 includes a receipt stub 410 and the main portion 420 of the instrument itself. The receipt stub 410 includes the following: an issuer logo 412 on the right hand side; usage instructions 414 at the upper and lower edges; the main serial number field 418 (333333360, in the example shown) with a check digit “8” appended to it; a summary box 418, containing a repetition of the serial number 419, the amount 415, the date 417 and related information.

The instrument main portion 420 includes: the serial number (333333360, in the example) printed (1) in a vertically-extending field 422 along the left hand margin of the instrument; (2) in the right half of the MICR line 424 at the bottom; and (3) in an identification field 426 in the upper right hand corner. The appearances of the serial number in the left hand margin of the instrument, in the MICR line 424 and the upper right hand corner of the receipt stub all include an “8” appended at the end of the serial number as a check digit developed at the terminal.

As can further be seen, the main portion 420 of the instrument itself also has an issuers logo printed on it in a logo field 430 in the upper left hand corner. In addition, in the upper right hand corner there is a date field 432 above the serial number identification field 426 and an instrument type field 434 immediately below the serial number identification field 426. Further, the main portion 420 includes a field 436 for security feature explanatory text, a pay to the order field 438, a purchaser field 440 and (for money orders) a recipient field 442. Finally, there are an amount field 450 containing the amount in figures and text, a “payable through” and issuer/drawer identification field 460 and a transaction identification and tracking field 444 containing various numbers in the lower right hand corner. The MICR; line 424 includes in the left hand portion routing and transit information (091900533, in the example). All this printed information is either provided to the terminal as part of its profile or generated or input as part of a transaction information leading to issuing an instrument. Thus, the complete, serial numbered instrument can be printed at the time of issue of the instrument. The presence of the information in the MICR line 424 permits automated processing as required by the clearing system 222, including participant banks.

Instruments other than money orders are similar with certain variations in fields to accommodate their use on a gift certificate, a payroll or other check, a money order for a trustee payment to a vendor, or a money order for trustee reimbursement.

Suspect Pay Report

As seen in FIG. 2, the trustee terminals send reports of issued instrument serial numbers on a periodic basis to the Outstanding Items & Fraud Detection System 220 over communication link 242, which also receives clearing information from clearing system 222, over communication link 244. The convergence of this information permits the development of a suspect pay report 240. This report will include all items covered on a given clearing day and will report items that have previous duplicate clearing with the same serial number. For example, the report on duplicate clearing would include for both the current clearing day and the prior clearing day: Instrument serial number, dollar amount, item sequence and account number. A suspect pay report may also include information on other clearing irregularities that may be detected from analysis of the clearing information and its reconciliation with the issued instrument and other transaction information reported from trustee terminals.

Compatibility

While it would be desirable for a payment instrument system to have only virtual inventory for serial numbers, due to the outstanding installed base of printers that are not equipped for MICR printing, this may not be possible. Thus, in one embodiment the physical inventory system in the warehouse 210 is left intact for warehousing and orders for pre-printed, serial numbered blank forms that are not part of the virtual inventory. However, that system is provided certain serial number inventory information for virtual inventory, just as if physical inventory of pre-printed serial-numbered blank forms were involved. This is possible by creating a special order code for serial number orders directed to the virtual inventory. These orders do not contribute to any actual stock picking or shipment from the warehouse of physical inventory of pre-printed serial-numbered blank forms. Thus, an instrument order that is a serial number order from virtual inventory can be mixed with other orders for physical inventory of preprinted serial-numbered blank forms. The serial number order for virtual inventory is processed by the Serial Number Virtual Inventory System 230 and can be passed as a no action or virtual order to the physical inventory system.

The blank stock used for MICR printing with micro-batch serial numbers becomes one more item in the inventory of non-serial numbered items, such as printing ribbons or print cartridges. Thus, trustee terminal needs for blank stock result in orders to and shipments from the physical inventory system, separate from any orders for virtual serial numbers, and both remain in adequate supply at the trustee terminal level. Trustee terminals can send such blank stock orders to the warehouse 210 directly over communications link 246, or the orders can be sent to the Serial Number Virtual Inventory System 230 via communications link 232 and forwarded to the warehouse 210 by that system.

Training Numbers

To facilitate training, the Serial Number Virtual Inventory System 230 can set up a training batch of virtual serial numbers. These can be used by any terminal; alternatively, a training batch can be made large enough to allow partitioning into separate training batches for each account 32, 34, 36 or for each trustee terminal. Assignments of the serial numbers in a training batch may be communicated to a trustee terminal as part of its terminal profile or an update to its profile. The trustee terminal printer software always recognizes these training serial numbers as for training instruments and causes the instrument printed to bear a VOID marking. Thus, no actual serial numbers in an authorized micro-batch need to be consumed for training, and the training batch of serial numbers can be reused. If desired, the use of these training numbers can be included in trustee terminal records periodically reported to the Serial Number Virtual Inventory System 230 for tracking.

Indirect Number Allocation

In the embodiments described above, specific serial number ranges are selected for inclusion in virtual inventory and those virtual serial numbers are used to fill trustee terminal orders and are then actually printed on checks at the trustee terminal to which the particular numbers are assigned. In another embodiment, each serial number to be assigned is associated with a key or index value. A key or index value range is assigned to a trustee terminal. Instead of using the key or index value directly as a serial number, the trustee terminal consults an association table or file that associates the key or index value with an actual serial number and thereby acquires a serial number that is associated with the key or index value. Alternatively, there may exist a rule for generating serial numbers to be printed that can be communicated or activated by information specifying a micro-batch. That is, there need not be direct correspondence between numbers allocated to a trustee terminal in a micro-batch and the numbers printed; assignment of a number that leads to a number or communication of an algorithm or input to an algorithm for generating a number is also possible. Such a system may have security or other advantages, such as a greater ability to keep printed numbers consecutive from micro-batch to micro-batch, notwithstanding an apparent prior allocation at the macro-batch level.

Operational Flowcharts

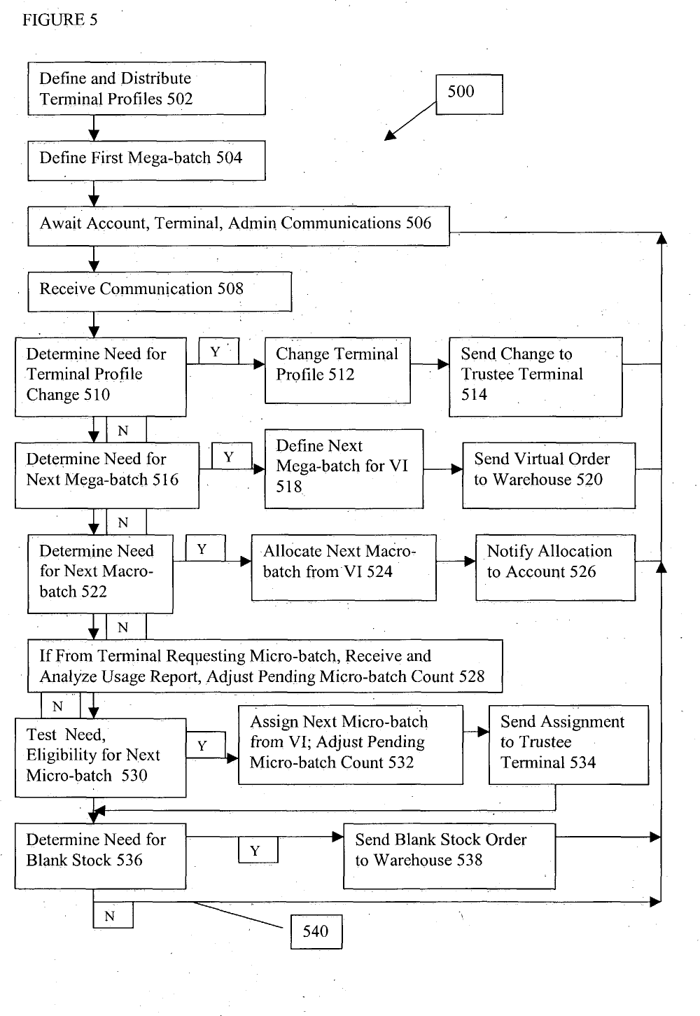

As seen in FIG. 5, the overall operation of one embodiment can be described from the viewpoint of the Serial Number Virtual Inventory System 230 by reference to flowchart 500. At step 502 the Serial Number Virtual Inventory System 230 defines and distributes the trustee terminal profiles as part of initialization. As noted above, these can include the replenishment threshold(s), the reporting profile specifying the schedule for issued instrument reporting for accumulated recent transactions, logos, formats for various kinds of instruments permitted from the terminal and other business rules that govern use of each trustee terminal for specified transactions. At step 504, the first mega-batch is defined, including any associated R&T information. At step 506, the system awaits communications that may come in from the accounts, the trustee terminals and the administration layer 208 of the system (see FIG. 2). At step 508, a communication is received for processing. At step 510, the communication is examined to determine if it requires a terminal profile change. If so, the change to the terminal profile is implemented at step 512 and sent to the applicable trustee terminals at step 514. The system returns to step 506 to await further communications. If a terminal profile change is not required, at step 516, the communication is examined to determine if it requires a next mega-batch to be defined. This communication may be issued by a component of the Serial Number Virtual Inventory System 230 at some convenient checkpoint, e.g., after all daily reports from trustee terminals have been received, such that rates of use and remaining serial numbers in the current mega-batch can be analyzed. If a next mega-batch is to be defined, the next mega-batch is defined for the virtual inventory (VI) at step 518, and at step 520 a virtual order is sent to the warehouse 210. The system returns to step 506 to await further communications. As explained above, this virtual order does not result in any actual printing of preprinted instruments for the new mega-batch. If a next mega-batch is not required, at step 522, the communication is examined to determine if it requires a next macro-batch. If so (due, e.g., to an account order or analysis of account status by a component of the Serial Number Virtual Inventory System 230), the macro-batch is allocated from the mega-batch virtual inventory at step 524 and the allocation is notified to the account requiring it at step 526. The system returns to step 506 to await further communications.

If a next macro-batch is not required, at step 528, the communication is examined to determine if it is from a trustee terminal and requests a next micro-batch to be assigned and authorized to the trustee terminal. To issue a next micro-batch, there is both a need test based on remaining available serial numbers relative to replenishment thresholds and an eligibility test. The latter is based on a batch count limit parameter as compared to a pending micro-batch count. Even where a need test is met, to avoid problems that might arise from a trustee having too many serial numbers pending either (a) in its to-be-reported issued instruments records or (b) in authorized, yet-to-be-used micro-batches, the Serial Number Virtual Inventory System 230 has a selectable parameter that limits the pending micro-batches any trustee terminal can have either in category (a) or (b). In one embodiment, the batch count limit parameter is three for all terminals; however, other values may be selected, based on the selected size for micro-batches, scheduled issued instrument reporting (usage report) frequency or other parameters, or general sense of risk associated with trustee terminals. In one embodiment, different trustee terminals are assigned different batch count limit parameters.

A pending micro-batch count is maintained for each terminal by adding to it when a micro-batch is assigned and subtracting from it when all serial numbers in a micro-batch have been reported as issued instruments to the Serial Number Virtual Inventory System 230. Before making the comparison between the batch count limit parameter and the pending micro-batch count (see step 530), the issued instrument records (usage report) typically included with a terminal communication requesting a micro-batch are received and analyzed at step 528. These records may make one or more pending micro-batches fully accounted for. If so, the pending micro-batch count is adjusted downward at step 528 to reflect this, before proceeding to step 530. If step 530 determines that the batch count limit parameter would not be exceeded by a new micro-batch and the need test based on a threshold are met, eligibility is satisfied. The next micro-batch can be taken for assignment from the virtual inventory (VI) (it typically comes from a prior macro-batch allocation) at step 532, and the pending micro-batch count is adjusted upward. At step 534 the assignment and authorization for the next micro-batch are sent to the particular trustee terminal that requires it. The system then returns control to step 536.

If, on the other hand, step 530 determines that the batch count limit parameter would be exceeded by a new micro-batch, then no micro-batch will be authorized at step 530; rather, communicating authorization for a replenishment micro-batch will be deferred until such time as the pending micro-batch count has been adjusted downward, as a result of issued instrument reports. (Administrative override of the batch count limit parameter by the issuer is also possible.)

If a next micro-batch was not required or permitted or a next micro-batch assignment is made, at step 536, the communication is examined to determine if it requires blank stock to be ordered and shipped to a trustee terminal. This may be a result of an express order from a trustee terminal or one that is determined by analysis of issued instrument records. If blank stock is needed, a blank stock order is sent to the warehouse 210 at step 538. The system returns to step 506 to await further communications. If no blank stock order is needed, the system also returns to step 506 to await further communications.

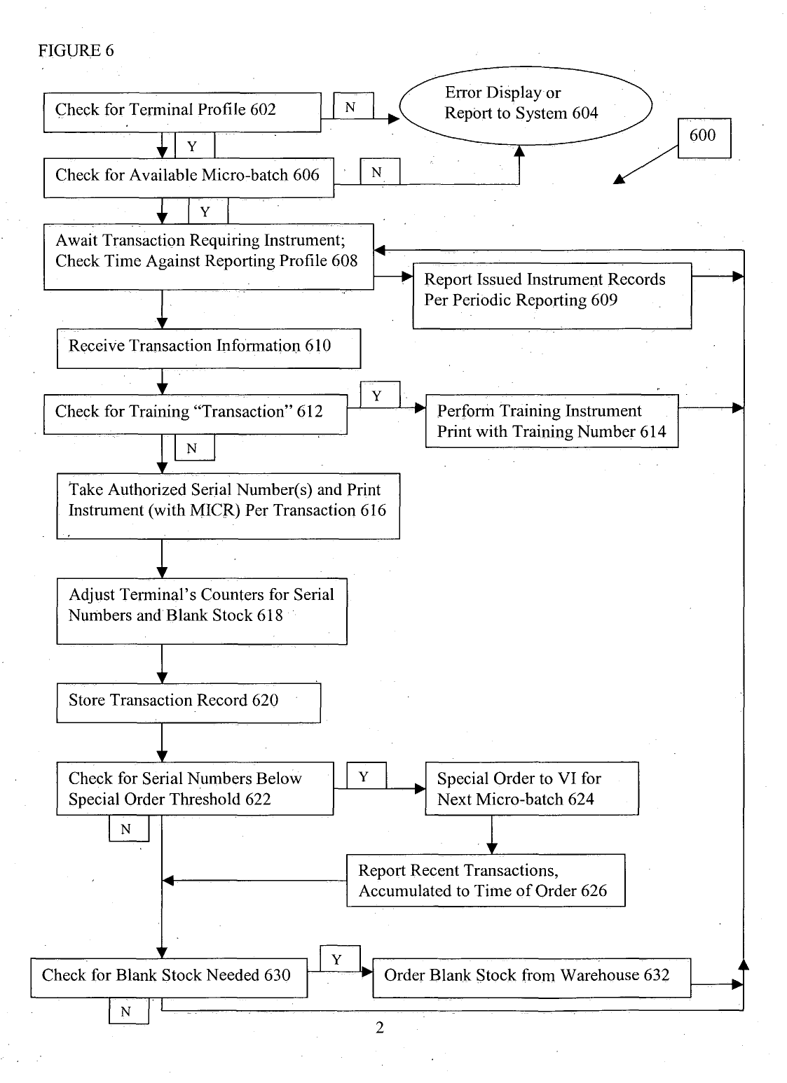

Turning now to FIG. 6, the overall operation of one embodiment from the viewpoint of a trustee terminal T can be described by reference to flowchart 600. At step 602, the terminal checks to ensure it has a terminal profile to govern its operations. If not, at step 604, it creates an error display for the terminal and reports to the Serial Number Virtual Inventory System 230. If there is a terminal profile, the terminal proceeds to step 606, where it checks for an available serial number in a micro-batch. If the terminal has none, it proceeds to step 604, where it creates an error display for the terminal and reports to the Serial Number Virtual Inventory System 230. If there is an available serial number in a micro-batch (normally the case), then the terminal proceeds to step 608 where it awaits transaction information and also checks the current time/date against the predetermined time/date criteria for its next issued instrument record report (usage report) as scheduled by the periodic reporting requirement in the terminal profile.

If while waiting at step 608, the terminal determines that the time/date criteria for its next issued instrument record report is met, it will proceed to step 609, where the terminal provides issued instrument records in a usage report to the Serial Number Virtual Inventory System 230. This report will be analyzed in the manner described above, to determine if the pending micro-batch count needs to be adjusted because a micro-batch is now fully accounted for by issued instruments. Control is then returned to step 608.

If while waiting at step 608, the terminal is sent transaction information, it receives the transaction information at step 610 and then proceeds to step 612. At step 612, the terminal checks for a training “transaction.” If a training “transaction” is determined, then at step 614, the terminal proceeds to perform printing of a training instrument with a training serial number. This does not involve using a serial number from an authorized micro-batch. The terminal then returns to step 608 to await a transaction requiring an instrument.

If a training “transaction” was not determined, the terminal proceeds with the transaction information to step 616 where it takes one or more authorized serial numbers from its current available micro-batch(es) and with use of the other transaction information, such as amount, instrument type, etc, causes the secure printer to print one or more instruments for the transaction. Each instrument is then ready for issue. At step 618, the terminal adjusts its counts for available serial numbers in the current micro-batch(es) and for blank stock, to reflect the instrument(s) just issued. Next, at step 620, the terminal stores an issued instrument(s) record of the transaction for batch transmittal in accordance with its reporting profile timing requirements (see steps 608, 609) or a special serial number order.

At step 622, the terminal checks the available serial number count (serial numbers in allocated, pending micro-batches, less issued instruments) to see if it has fallen below the special order threshold. If the count is below the special order threshold, at step 624 the terminal issues a special order communication to the Serial Number Virtual Inventory System 230 for its next micro-batch. In the same communication, per step 626, the terminal provides an issued instrument usage report of accumulated recent transactions, including the serial number usage status. This may result in the pending micro-batch count at Serial Number Virtual Inventory System 230 being reduced, if one of the authorized micro-batches now has all its serial numbers covered as issued instruments by the usage report. Once the issued instrument report is made at step 626 or if the threshold for a special order of serial numbers is not met at step 622, the terminal proceeds to step 630 where the terminal checks the blank stock count and determines if an order for blank stock for the terminal is needed. If the count indicates the need for blank stock, at step 632 the terminal issues an order for blank stock, to be communicated directly or indirectly to the warehouse 210. Control returns to step 608 to await a transaction requiring an instrument or a periodic reporting requirement. If blank stock is not required, control still returns to step 608.

From the proceeding, it will be understood that the communications from the terminal should maintain at least one partially available micro-batch of serial numbers for each terminal. In some cases, a micro-batch that is in use will be consumed by issuing instruments, before a periodic usage report is called for. Due to the special order replenishment threshold, this should not occur without a special order for serial numbers being issued and a new micro-batch authorized in response to that order. Thus, a terminal may have two current micro-batches, one entirely consumed (e.g., serial nos. 51-100) and at least in part visible in the issued instrument records to be reported with a periodic usage report and a second micro-batch (e.g., serial nos. 101-150) that is partially used and was supplied in response to a special order. If the special order threshold is met on the second micro-batch before the periodic reporting occurs, then another special order is issued and a third micro-batch may be authorized (e.g., serial nos. 151-200). However, if the batch count limit parameter is set at three, then no new (fourth) micro-batch will be authorized for this terminal until all serial numbers in one of the pending micro-batches are covered by issued instrument records that are reported to the Serial Number Virtual Inventory System 230. A terminal may also have assigned a batch of training serial numbers that also represent a current serial number inventory, although they cause only VOID instruments to be printed.

Although the subject invention has been described with reference to preferred embodiments, persons skilled in the art will recognize that changes may be made in form and detail without departing from the spirit and scope of the invention.

1. A method for managing a virtual inventory of payment instruments to be issued by a trustee on behalf of an issuer, comprising:
providing one or more blank instruments to the trustee;
defining a batch of virtual serial numbers for use on the one or more blank instruments for specified transactions;
communicating to the trustee an authorization to print payment instruments using such batch of virtual serial numbers on the one or more blank instruments; and receiving a usage report from the trustee stating the serial numbers used and related transaction information.

2. The method of claim 1 further comprising storing the usage report and receiving clearing information and reconciling the clearing information with the usage report from the trustee.

3. The method of claim 1 further comprising defining a replenishment threshold, wherein the step of defining a batch of virtual serial numbers comprises defining a limited batch of virtual serial numbers and responsive to the reports from the trustee and the defined replenishment threshold, defining a replenishment batch of virtual serial numbers and communicating to the trustee an authorization to print payment instruments using such replenishment batch of virtual serial numbers.

4. The method of claim 3 further comprising associating a batch count limit with the trustee, maintaining a pending batch count and responsive to a comparison of the batch count limit and the pending batch count, deferring communicating to the trustee an authorization to print payment instruments using such replenishment batch of virtual serial numbers.

5. The method of claim 3 wherein the step of defining a replenishment threshold comprises defining a first replenishment threshold for use with a usage report from the trustee that is produced on a scheduled basis.

6. The method of claim 3 wherein the step of defining a replenishment threshold comprises defining a second replenishment threshold for use with a usage report from the trustee that is produced on an unscheduled basis, when the trustee determines the second replenishment threshold is met.

7. The method of claim 1 wherein the step of defining a batch of virtual serial numbers for use on the one or more blank instruments for specified transactions comprises defining a batch of virtual serial numbers for use on the one or more blank instruments for at least one of the following transactions: a money order sold to a customer, a gift certificate, a payroll or other check, a money order for a trustee payment to a vendor, or a money order for trustee reimbursement.

8. The method of claim 1 wherein the trustee is a secure printer.

9. The method of claim 1 further comprising receiving clearing information and determining from the clearing information items to be included in a suspect pay report.

10. The method of claim 1 further comprising receiving clearing information and determining from the clearing information items to be included in a suspect pay report identifying duplicate presentment of payment instruments.

11. The method of claim 1 wherein the step of communicating to the trustee an authorization to print payment instruments using such batch of virtual serial numbers comprises communicating the serial numbers to be printed.

12. The method of claim 1 wherein the step of communicating to the trustee an authorization to print payment instruments using such batch of virtual serial numbers comprises communicating a set of key numbers that is associated with the serial numbers to be printed.

13. The method of claim 1 wherein the step of communicating to the trustee an authorization to print payment instruments using such batch of virtual serial numbers comprises communicating a rule for generating the serial numbers to be printed.

14. The method of claim 1 further comprising providing a physical inventory system for handling inventory of a stock of serial-numbered blank instrument forms, not part of the virtual inventory.

15. The method of claim 14 wherein the physical inventory system is a legacy system that handles printing orders and inventory of serial-numbered blank instrument and further comprising submitting virtual orders for the virtual inventory to be handled by the physical inventory system but with the corresponding printing order inhibited.

16. The method of claim 1 further comprising defining a training batch of virtual serial numbers and communicating to the trustee an authorization to print on the blank instruments void instruments using serial numbers from the training batch.

17. The method of claim 1, further comprising defining a terminal profile for a trustee terminal associated with a trustee, said terminal profile defining specified transactions for which the trustee terminal may print instruments.

18. The method of claim 17, wherein the step of defining a terminal profile includes specifying routing and transit information for inclusion in the. MICR of a payment instrument printed at the trustee terminal.

19. The method of claim 17 further comprising defining a replenishment threshold, where such replenishment threshold is configurable as part of the terminal profile.

20. The method of claim 1, further comprising defining a mega-batch of virtual serial numbers for use by multiple trustees and wherein the step of defining a batch of virtual serial numbers for use on the one or more blank instruments for specified transactions comprises defining a limited subset of the mega-batch as a micro-batch for use by a specified trustee terminal.

21. A method for using a virtual inventory of payment instruments to be issued by a trustee on behalf of an issuer, comprising:
receiving one or more blank instruments at the trustee;
receiving at the trustee an authorization to print payment instruments using a batch of virtual serial numbers defined for use on the one or more blank instruments for specified transactions;
printing at least one payment instrument for a transaction using such batch of virtual serial numbers on the one or more blank instruments; and
providing to the issuer a usage report from the trustee stating the serial numbers used and related transaction information.

22. The method of claim 21 further comprising receiving at the trustee clearing information and reconciling the clearing information with the usage report from the trustee stating the serial numbers used and related transaction information.

23. The method of claim 21 further comprising defining a replenishment threshold, wherein the step of receiving at the trustee a batch of virtual serial numbers comprises receiving a defined, limited batch of virtual serial numbers and further comprising responsive to the defined replenishment threshold, receiving at the trustee a replenishment batch of virtual serial numbers and an authorization to print payment instruments using such replenishment batch of virtual serial numbers.

24. The method of claim 23 further comprising the trustee providing in such usage reports information for maintaining a pending batch count and following a comparison of a batch count limit and the pending batch count determining that the batch count limit is not exceeded, receiving at the trustee an authorization to print payment instruments using such replenishment batch of virtual serial numbers.

25. The method of claim 21 wherein the step of defining a replenishment threshold comprises defining a first replenishment threshold for use with a usage report from the trustee that is produced on a scheduled basis.

26. The method of claim 21 wherein the step of defining a replenishment threshold comprises defining a second replenishment threshold for use with a usage report from the trustee that is produced on an unscheduled basis, when the trustee determines the second replenishment threshold is met.

27. The method of claim 21 wherein the step of receiving at the trustee an authorization to print payment instruments using a batch of virtual serial numbers defined for use on the one or more blank instruments for specified transactions comprises defining a batch of virtual serial numbers for use on the one or more blank instruments for at least one of the following transactions: a money order sold to a customer, a gift certificate, a payroll or other check, a money order for a trustee payment to a vendor, or a money order for trustee reimbursement.

28. The method of claim 21 wherein the trustee is a secure printer.

29. The method of claim 21 further comprising the issuer receiving clearing information and determining from the clearing information items to be included in a suspect pay report.

30. The method of claim 21 further comprising the issuer receiving clearing information and determining from the clearing information items to be included in a suspect pay report identifying duplicate presentment.

31. The method of claim 21 wherein the step of receiving at the trustee an authorization to print payment instruments using such batch of virtual serial numbers comprises receiving the serial numbers to be printed..

32. The method of claim 21 wherein the step of receiving at the trustee an authorization to print payment instruments using such batch of virtual serial numbers comprises receiving a set of key numbers that is associated with the serial numbers to be printed.

33. The method of claim 21 wherein the step of receiving at the trustee an authorization to print payment instruments using such batch of virtual serial numbers comprises receiving a rule for generating the serial numbers to be printed.

34. The method of claim 21 further comprising providing a physical inventory system for handling inventory of a stock of blank payment instrument forms, not part of the virtual inventory.

35. The method of claim 34 wherein the physical inventory'system is a legacy system that handles printing orders and inventory of payment instrument forms bearing serial numbers and further comprising submitting virtual orders for the virtual inventory to be handled by the physical inventory system but with the corresponding printing order inhibited.

36. The method of claim 21 further comprising receiving a training batch of virtual serial numbers and authorization to print on the blank instruments void instruments using serial numbers from the training batch.

37. The method of claim 21, further comprising receiving a terminal profile at a trustee terminal associated with a trustee, said terminal profile defining specified transactions for which the trustee terminal may print instruments.

38. The method of claim 37, wherein the step of receiving a terminal profile includes receiving a profile specifying routing and transit information for inclusion in the MICR of a payment instrument printed at the trustee terminal.

39. The method of claim 37 further receiving a defined replenishment threshold, where such replenishment threshold is configurable as part of the terminal profile.

40. The method of claim 21, further comprising defining a mega-batch of virtual serial numbers for use by multiple trustees and wherein the step of receiving at the trustee an authorization to print payment instruments using a batch of virtual serial numbers defined for use on the one or more blank instruments for specified transactions comprises receiving a limited subset of the mega-batch as a micro-batch for use by a specified trustee terminal.

41. A method for managing a virtual inventory of payment instruments to be issued by a trustee on behalf of an issuer using blank payments instruments with no serial number, comprising:
defining a batch of virtual serial numbers for use on the one or more blank instruments for specified transactions;
communicating to the trustee an authorization to print payment instruments using such batch of serial numbers on the one or more blank instruments; and
receiving a usage report from the trustee stating the serial numbers used and related transaction information.

42. The method of claim 41 further comprising storing the usage report and receiving clearing information and reconciling the clearing information with the usage report from the trustee stating the serial numbers used and related transaction information.

43. The method of claim 41 further comprising defining a replenishment threshold, wherein the step of defining a batch of virtual serial numbers comprises defining a limited batch of virtual serial numbers and responsive to the reports from the trustee and the defined replenishment threshold, defining a replenishment batch of virtual serial numbers and communicating to the trustee an authorization to print payment instruments using such replenishment batch of virtual serial numbers.

44. The method of claim 43 further comprising associating a batch count limit with the trustee, maintaining a pending batch count and responsive to a comparison of the batch count limit and the pending batch count, deferring communicating to the trustee an authorization to print payment instruments using such replenishment batch of virtual serial numbers.

45. The method of claim 43 wherein the step of defining a replenishment threshold comprises defining a first replenishment threshold for use with a usage report from the trustee that is produced on a scheduled basis.

46. The method of claim 43 wherein the step of defining a replenishment threshold comprises defining a second replenishment threshold for use with a usage report from the trustee that is produced on an unscheduled basis, when the trustee determines the second replenishment threshold is met.

47. The method of claim 41 wherein the step of defining a batch of virtual serial numbers for use on the one or more blank instruments for specified transactions comprises defining a batch of virtual serial numbers for use on the one or more blank instruments for at least one of the following transactions: a money order sold to a customer, a gift certificate, a payroll or other check, a money order for a trustee payment to a vendor, or a money order for trustee reimbursement.

48. The method of claim 41 wherein the trustee is a secure printer.

49. The method of claim 41 further comprising receiving clearing information and determining from the clearing information items to be included in a suspect pay report.

50. The method of claim 41 further comprising receiving clearing information and determining from the clearing information items to be included in a suspect pay report identifying duplicate presentment of payment instruments.

51. A program storage device readable by a machine, embodying a program of instructions executable by the machine to perform method steps for managing a virtual inventory of payment instruments to be issued by a trustee on behalf of an issuer using blank payments instruments with no serial number, said method steps comprising:
defining a batch of virtual serial numbers for use on the one or more blank instruments for specified transactions;
communicating to the trustee an authorization to print payment instruments using such batch of virtual serial numbers on the one or more blank instruments; and
receiving a usage report from the trustee stating the serial numbers used and related transaction information.

52. The program storage device of claim 51 wherein the method steps further comprise receiving clearing information and reconciling the clearing information with the usage report from the trustee stating the serial numbers used and related transaction information.

53. The method of claim 51 further comprising defining a replenishment threshold, wherein the step of defining a batch of virtual serial numbers comprises defining a limited batch of virtual serial numbers and responsive to the reports from the trustee and the defined replenishment threshold, defining a replenishment batch of virtual serial numbers and communicating to the trustee an authorization to print payment instruments using such replenishment batch of virtual serial numbers.

54. The method of claim 53 further comprising associating a batch count limit with the trustee, maintaining a pending batch count and responsive to a comparison of the batch count limit and the pending batch count, deferring communicating to the trustee an authorization to print payment instruments using such replenishment batch of virtual serial numbers.

55. The method of claim 53 wherein the step of defining a replenishment threshold comprises defining a first replenishment threshold for use with a usage report from the trustee that is produced on a scheduled basis.

56. The method of claim 53 wherein the step of defining a replenishment threshold comprises defining a second replenishment threshold for use with a usage report from the trustee that is produced on an unscheduled basis, when the trustee determines the second replenishment threshold is met.

57. The method of claim 51 wherein the step of defining a batch of virtual serial numbers for use on the one or more blank instruments for specified transactions comprises defining a batch of virtual serial numbers for use on the one or more blank instruments for at least one of the following transactions: a money order sold to a customer, a gift certificate, a payroll or other check, a money order for a trustee payment to a vendor, or a money order for trustee reimbursement.

58. The method of claim 51 wherein the trustee is a secure printer.

59. The method of claim 51 further comprising receiving clearing information and determining from the clearing information items to be included in a suspect pay report.

60. The method of claim 51 further comprising receiving clearing information and determining from the clearing information items to be included in a suspect pay report identifying duplicate presentment of payment instruments.

61. A system of managing a virtual inventory of payment instruments to be issued by a trustee on behalf of an issuer, comprising:
an inventory warehouse for providing one or more blank instruments to the trustee;
an issuer data processing system for defining a batch of virtual serial numbers for use on the one or more blank instruments for specified transactions;
a communication link for communicating from the issuer system to the trustee an authorization to print payment instruments using such batch of virtual serial numbers on the one or more blank instruments; and
a report link for receiving a usage report from the trustee stating the serial numbers used and related transaction information.
